(19) United States
(12) Patent Application Publication
(10) Pub. No.: US 2010/0243369 A1
(43) Pub. Date: Sep. 30, 2010

(54) HIGHWAY NOISE BARRIER

(75) Inventors: Boguslaw Fusiek, Dorchester, MA (US); Adam Warchol, Chocianow (PL); Wojciech Zimny, Lubin (PL); Adam Figurski, Zukowice (PL)

Correspondence Address: COOK ALEX LTD, SUITE 2850, 200 WEST ADAMS STREET, CHICAGO, IL, 60606, US

(73) Assignee: NUFORM BUILDING TECHNOLOGIES INC., Woodbridge, ON (CA)

(21) Appl. No.: 12/415,524

(22) Filed: Mar. 31, 2009

(51) Int. Cl. G10K 11/00

(52) U.S. Cl. 181/210

(57) ABSTRACT

A highway noise barrier panel assembly has a base panel, sound-attenuating insulation located adjacent an exterior surface of the base panel and an insulation retaining structure to secure the insulation in fixed relation to the base panel. A noise barrier has at least two generally vertical support posts, at least one wall panel with sides attached to the support posts, sound-attenuating insulation located adjacent an exterior surface of the wall panel and an insulation retaining structure to secure the insulation in fixed relation to the base panel. Additionally, a noise barrier retrofit kit adapted to be attached to a wall surface is provided with at least two channel-defining members adapted to be mounted to the wall surface in generally parallel spaced apart relationship, so as to define an insulation receiving channel therebetween, sound-attenuating insulation adapted to be located in such channel and at least one insulation retaining structure adapted to be secured to the channel-defining members whereby to hold the insulation in place. Further, a noise barrier having a wall surface, at least two channel-defining members mounted to the wall surface in generally parallel spaced apart relationship, so as to define an insulation receiving channel therebetween, sound-attenuating insulation located in such channel and an insulation retaining structure secured to the channel-defining members whereby to hold the insulation in place is provided.

### FIELD OF THE INVENTION

The invention relates to an exterior noise barrier, such as would be used along transportation corridors, such as highways and railway lines.

### BACKGROUND OF THE INVENTION

Noise barriers are erected in exterior areas where it is desired to reduce noise transmitted from one zone to another. Typical locations for such noise barriers are beside busy highway and railway corridors, where it is desired to reduce the level of noise emanating from traffic moving along these corridors into adjacent residential zones.

Common noise barriers are walls consisting of pre-cast reinforced concrete wall sections attached to appropriate support posts spaced at regular intervals. Individual wall sections between support posts may be unitary pre-cast wall panels or an assembly of smaller, stacked wall panels. Such pre-cast panels typically are solid, not hollow. Concrete formulations used in some such panels may include sound absorbing components, such as wood fibres.

In some noise barriers, extruded thermoplastic panels have been used, with individual wall sections usually being an assembly of smaller, stacked wall panels. Such extruded thermoplastic panels are typically hollow. The hollow internal cavities are usually left void but, in some cases, such cavities have been filled with sound-absorbing insulation. Such thermoplastic panels are made with suitable compositions so as to be adequately protected from degradation by exposure to ultraviolet radiation from the sun.

All such panels suffer from various problems. The concrete panels, for example, are heavy and difficult to manipulate during fabrication, transportation and construction. Their heavy weight additionally means that the support post structures must be relatively robust so as to support the panels safely and effectively. In addition, their hard exterior surfaces reflect a significant amount of sound back into the environment, where it may eventually affect persons or activities in the area.

On the other hand, thermoplastic panels in which the internal cavities remain void are light-weight and may require less robust support. However, such panels do not necessarily provide an effective barrier to the passage of sound. Thermoplastic panels in which the internal cavities are filled with sound-absorbing insulation provide a more effective noise barrier and still remain relatively lightweight, but it can be laborious and therefore expensive to fill the internal cavities with sound-absorbing insulation, such as by cutting to the appropriate shapes and sizes. Like the concrete panels, the hard exterior surfaces of thermoplastic panels can reflect a significant amount of sound back into the environment.

Another problem with both of such prior art structures is that it is difficult to present decorative options for the panels. For example, typically the noise barrier made of a uniform material, whether concrete or extruded thermoplastic, will have the same uniform colour on each side of the barrier. In addition, it can be difficult to repair such structures, or change their colours, after installation.

There thus remains a continuing need for an effective, lightweight noise barrier and which may provide certain decorative design options.

### SUMMARY OF THE INVENTION

The present invention is directed, in one aspect, to a noise barrier panel assembly having a base panel, sound-attenuating insulation located adjacent an exterior surface of the base panel and an insulation retaining structure to secure the insulation in fixed relation to the base panel. In another aspect, the invention is a noise barrier with at least two generally vertical support posts, at least one wall panel with sides attached to the support posts, sound-attenuating insulation located adjacent an exterior surface of the wall panel and an insulation retaining structure to secure the insulation in fixed relation to the base panel. In yet a further aspect, the invention is a noise barrier retrofit kit adapted to be attached to a wall surface having at least two channel-defining members adapted to be mounted to the wall surface in generally parallel spaced apart relationship, so as to define an insulation receiving channel therebetween, sound-attenuating insulation adapted to be located in such channel and at least one insulation retaining structure adapted to be secured to the channel-defining members whereby to hold the insulation in place. In yet another aspect, the invention is a noise barrier having a wall surface, at least two channel-defining members mounted to the wall surface in generally parallel spaced apart relationship, so as to define an insulation receiving channel therebetween, sound-attenuating insulation located in such channel and an insulation retaining structure secured to the channel-defining members whereby to hold the insulation in place.

### IN THE DRAWINGS

Preferred embodiments of the present invention are illustrated in the attached drawings in which:

FIG. 1 is a perspective view of a noise barrier according to the invention;

FIG. 2 is a front perspective view of one section of a noise barrier according to the invention;

FIG. 3 is a perspective view, partially cut away, of a noise barrier panel assembly, supported along one side, according to the invention;

FIG. 4 is a cross-sectional view of a noise barrier panel assembly according to the invention, in which a portion of the sound-absorbing insulation has been cut away;

FIG. 5 is a cross-sectional view of an alternate embodiment of a face panel as may be incorporated into the invention;

FIG. 6 is a perspective view of a panel side structure as may be incorporated into the invention;

FIG. 7 is a perspective view of a panel side structure as may be incorporated into an alternate embodiment of the invention;

FIG. 8 is a front perspective view of one section of an alternate embodiment of a noise barrier according to the invention;

FIG. 9 is a perspective view of an alternate embodiment of a noise barrier panel assembly according to the invention;

FIG. 10 is a cross-sectional view of such alternate embodiment of a noise barrier panel assembly according to the invention;

FIG. 11 is a cross-sectional view of an alternate embodiment of the invention as may be used in a retrofit application.

### DETAILED DISCLOSURE

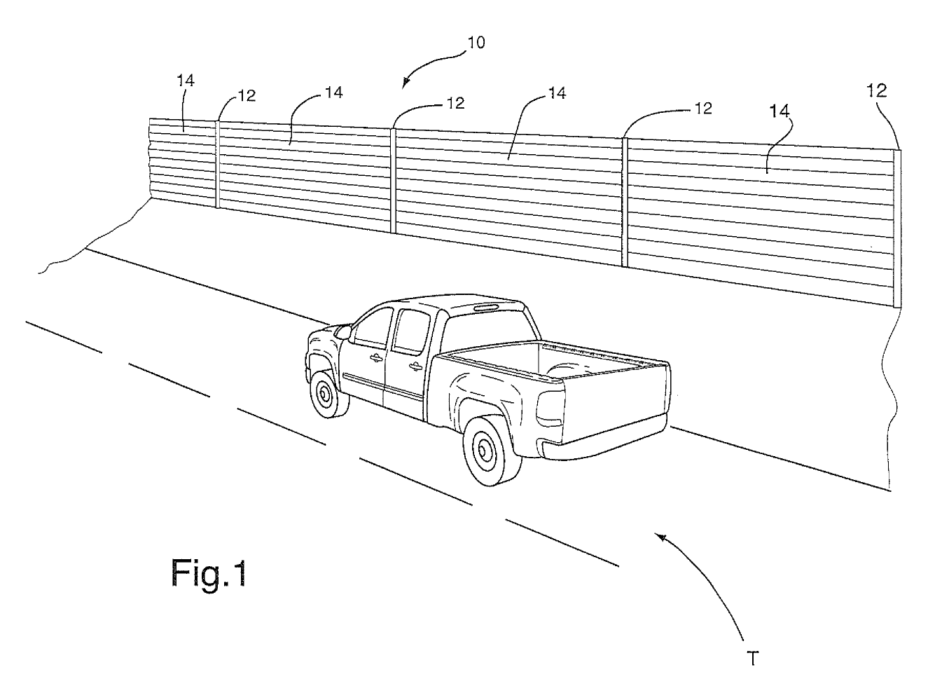

Referring to FIG. 1, there is generally shown a noise barrier 10 according to the invention. Noise barrier 10 is located adjacent a transportation corridor such as highway T. Noise barrier 10 will attenuate noise moving from transportation corridor T toward areas, such as residential areas on the other side of noise barrier 10.

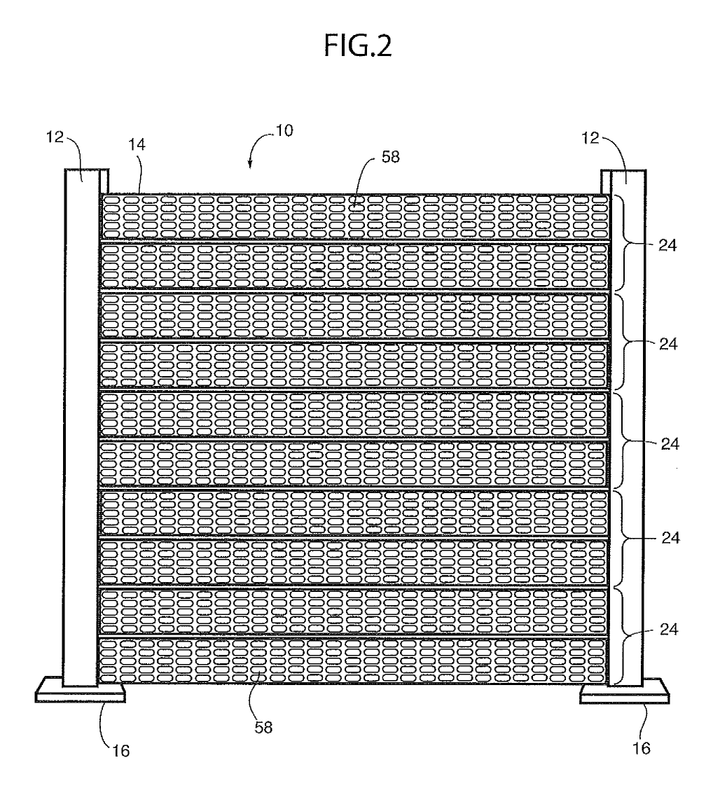

Noise barrier 10 comprises a series of supports, which are generally vertical support posts 12, to which wall panels 14 are attached. Preferably, the support posts are spaced at pre-determined regular intervals. As shown in FIG. 2, at a minimum, in a free-standing noise barrier 10, there will be at least two support posts 12 and at least one wall panel 14. In some cases, a wall panel 14 could be mounted to some other supporting structure, such as the side of a building, with only one end being supported by a post 12. Posts 12 are anchored to the ground by suitable means. As shown in FIG. 2, there may be base plates 16 at the bottoms of posts 12 which would in turn be mounted to suitable concrete walls, foundations or footings, not shown.

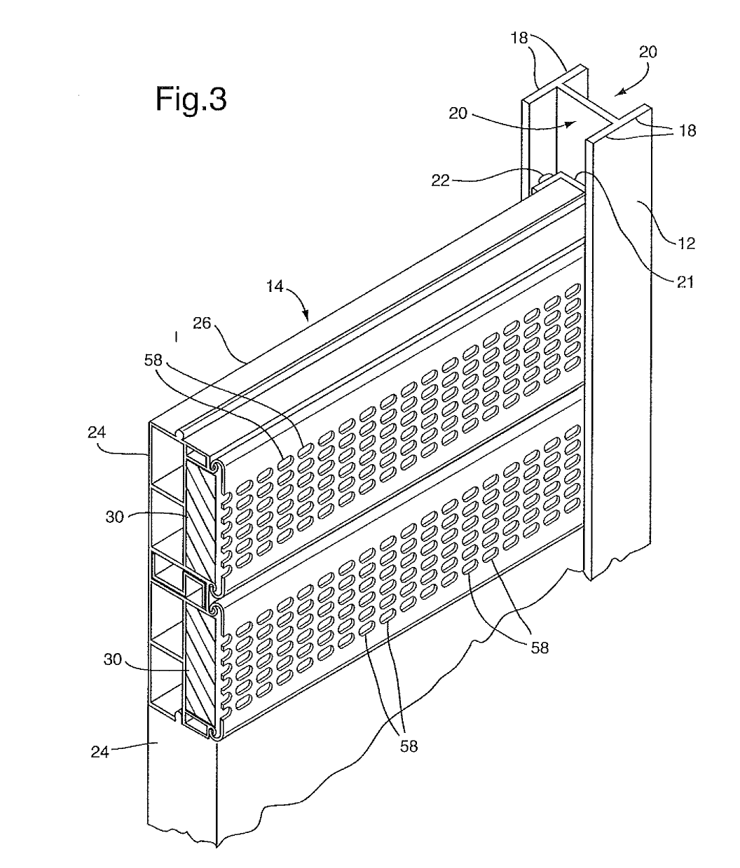

Referring to FIG. 3, a preferred form of support post 12 is a vertically oriented I-beam with flanges 18 and channels 20.

Wall panel 14 comprises at least one noise barrier panel assembly 24. In FIG. 2, wall panel 14 is shown as being comprised of five such panel assemblies 24, but any number could be used depending on the height of the noise barrier 10 and on the height of individual noise barrier panel assemblies 24.

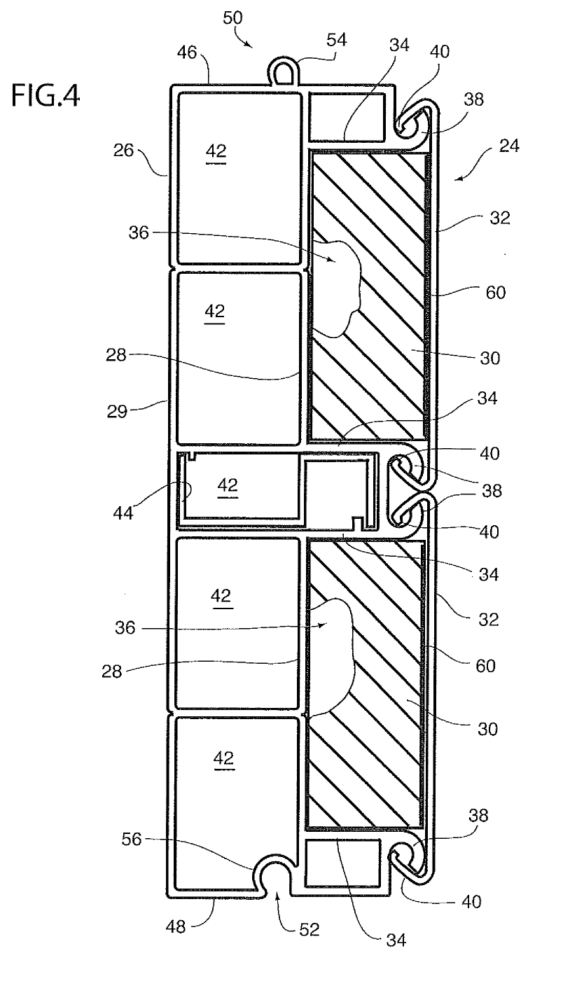

Referring now to FIGS. 3 and 4, the structure of the noise barrier assembly 24 is illustrated. Each panel assembly 24 includes a base panel 26. Preferably, base panel 26 is extruded from a thermoplastic material containing suitable agents to provide protection from ultraviolet exposure; however, other materials and manufacturing techniques could be used to fabricate a suitable base panel.

On an exterior surface 28 of base panel 26, sound-attenuating insulation 30 is secured. An example of a suitable sound-attenuating insulation material is water resistant, low moisture sorption ROXUL ROCKBOARD™ mineral wool fibre board insulation. Mineral wool densities for such mineral wool board insulation will preferably be in the range from about 50 to 200 kg/m³ depending on degree of sound absorption required. For normal usage, a mineral wool density of about 100 kg/m³ has been found to be satisfactory. Such mineral wool board insulation may be conveniently cut into batts of rectangular cross-section and suitable size. Preferably, sound insulation 30 has a moisture resistant layer 60 on one surface thereof. When the batts of insulation 30 are placed on exterior surface 28, in the illustrated embodiment, preferably they will be placed so that the moisture resistant layer 60 will be on the side of insulation 30 away from exterior surface 28.

Although insulation 30 could be attached to surfaces 28 by any suitable means (including adhesive or mechanical fasteners), it is preferable that insulation 30 be additionally retained in place and protected from external forces and agents by an insulation retaining structure. In the illustrated embodiment, such structure comprises face panels 32 which extend across the insulation 30 and are attached to base panel 26 on either side of the insulation 30. With or without the use of adhesive, face panels 32 secure the insulation 30 in fixed relation to base panel 26.

It is additionally preferable that structure be provided by base panel 26 to assist in the placement and secure retention of insulation 30. To this end, base panel 26 has channel walls 34 which extend outwardly from exterior surface 28, thereby defining channels 36 into which the batts of insulation 30 may be placed. A noise barrier panel assembly 24 may be provided with one or more such channels 36. In the illustrated embodiment, each panel assembly 24 has two such channels 36 and thus each such panel assembly 24 is illustrated with two locations where insulation 30 is affixed and two face panels 32 are used to secure same.

Preferably, base panel 26 and face panels 32 are provided with cooperating attachment structures whereby the face panels 32 may be conveniently attached to base panel 26. In the illustrated embodiment, the outer portion of channel wall 34 is provided with a hook-shaped lip 38 extending away from the adjacent channel 36. To cooperate therewith, face panels 32 are provided with face panel hook structures 40, adapted to engage with the hook-shaped lips 38 of base panel 26.

As previously noted, base panel 26 is preferably extruded from a thermoplastic material, in which case lips 38 extend the length of base panel 26 on either side of adjacent channels 36. Similarly, and preferably, face panels 32 will also be formed in a linear manufacturing process, such as steel roll-forming or extrusion of a thermoplastic material (containing suitable agents to provide protection from ultraviolet exposure) or other materials such as aluminum, whereby the face panel hook structures 40 will similarly extend the length of the face panels 32. Although preferable, it is not however necessary for the hook structures 38 or 40 to be integrally manufactured with base panel 26 or with face panel 32. Instead, separate hook attachments or other fasteners could be used to attach face panels 32 to base panel 26.

In assembly of a noise barrier panel assembly 24, it is possible for face panels 32 to be longitudinally slid into place from one end of base panel 26. Preferably however, face panels 32 with their hook structures 40 may be transversely snapped into place. This latter operation may be made easier by engaging a hook structure 40 and a corresponding lip 38 on one side of a channel 36 and then snapping the other hook structure 40 into place over and around the other lip 38. In a reverse removal operation, a face panel 32 may be transversely disengaged from lips 38 on the sides of channel 36.

To provide sufficient structural integrity and to achieve the required dimensions, panel 26 may be provided with various internal cavities 42. In the illustrated embodiment cavities 42 are left void. However, if additional sound absorption is required, it would be possible to fill cavities 42 with additional sound insulation material.

To assist in providing additional rigidity to panel assembly 24, one or more of cavities 42 may be provided with a stiffening member, such as the S-shaped member 44. Other structural member profiles, such as channels or I-beams, could be used. Such stiffening members 44 can be made from any suitable material such as steel or in some cases aluminum.

To assist in the proper alignment and securing together of adjacent panel assemblies 24, top and bottom surfaces 46 and 48, respectively, of base panel 26 are provided with cooperating upper and lower registration structures 50 and 52. In the particular embodiment shown, the top surface 46 is provided with outwardly extending ridge 54 and the bottom surface 48 provided with a corresponding inwardly extending groove 56. Adjacent panel assemblies 24 may therefore be fitted together by engaging a ridge 54 of one panel assembly 24 with a groove 56 of a neighbouring panel assembly 24.

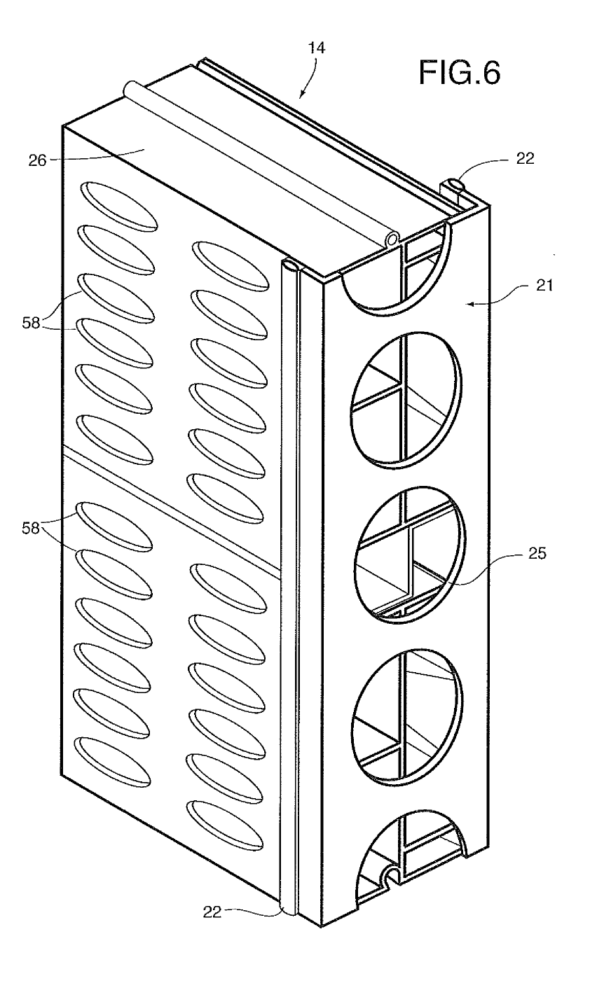

As shown in FIGS. 3 and 6, preferably face panels 32 are provided with a multiplicity of sound admitting slots or openings 58. If face panels 32 are extruded or roll formed, then openings 58 will be added in a separate stamping operation. As previously noted, when the batts of insulation 30 are placed into channels 36, layer 60 is preferably located away from exterior surface 28, so that in this manner it will be adjacent to face panel 32. In this arrangement, rain or other water that may enter into the panel assembly 24 through openings 58 will be repelled by layer 60 and thus be less likely to be absorbed by insulation 30 behind face panels 32 where, particularly if exposed to freeze-thaw cycles, there could be some risk of damage to the structure. It must be stated however that noise barrier 10 is not necessarily designed to be waterproof and the entry of at least some water into the structure is not expected to be problematic in a normal range of conditions.

Because the face panels 32 are separate components from the base panels 26, various colour and tone and other decorative options can be presented to the noise barriers users. For example, the face panels 32 can be of a different colour/tone compared to the colour/tone of the base panel 26. In addition, different colours/tones could be used for different face panels, giving a striping effect from top to bottom of barrier 10. In another embodiment (not shown), hook structures similar to lips 28 could be provided on an interior surface 29 of base panel 26. Such hook structures would allow face panels 32 to be located on that side of the noise barrier, so that persons on both sides of noise barrier 10 may have different colour and tone options and also the option of adding additional sound-attenuating insulation. Other decorative features (for example solid panels, panels with different surface textures and patterns, panels with different hole patterns, shapes or sizes) may also be applied to different face panels, giving an even wider range of decorative options.

In addition, because the face panels 32 are separate and removable components, face panels 32 may be changed as desired, for example either to achieve different esthetic effects or to repair damaged face panels.

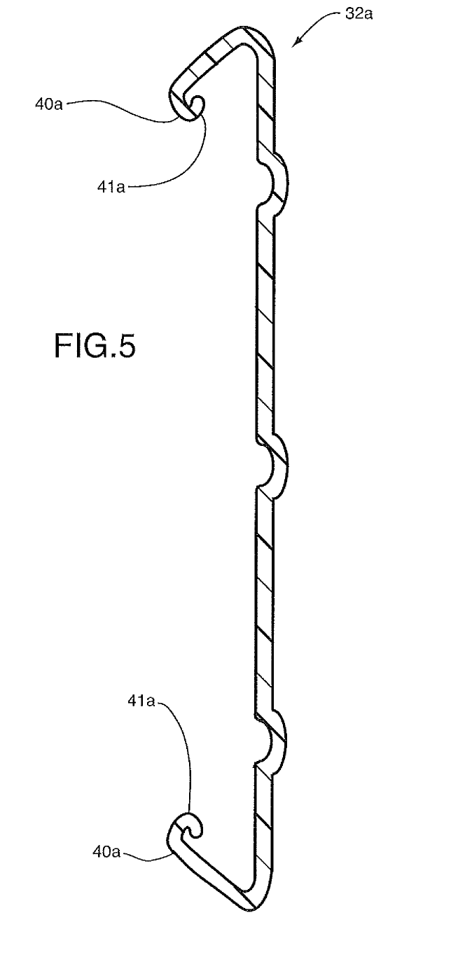

Referring now to FIG. 5, an alternate profile for a face panel 32 is shown. The hook structure 40a illustrated, which has a tip 41a doubling back on itself, is particularly robust and may be useful in certain applications or for certain face panel materials.

As shown in FIGS. 3 and 6, wall panel 14 is of a width which is approximately the width of channels 20 between I-beam flanges 18. Base panel 26 may be provided with an edge cap 21 which provides some protection to the edges of base panel 26. Sealing structures 22 are attached to base panel 26 adjacent edge cap 21. Wall panel 14 is securely held in place between flanges 18 by friction by means of the sealing structures 22 of its panel assemblies 24.

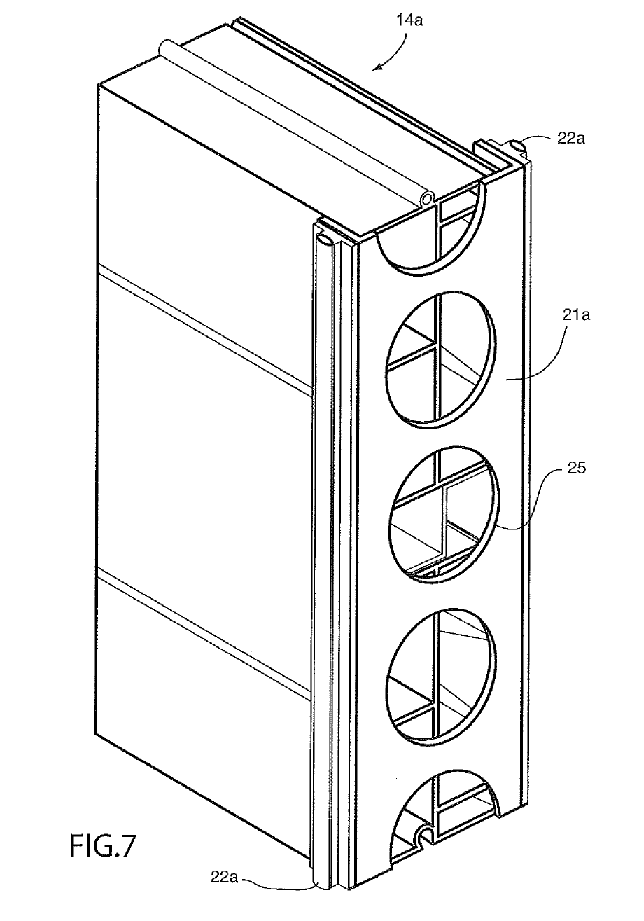

Referring to FIG. 7, an alternate version of an edge cap 21a and associated seals 22a are shown for wall panel 14a.

In the embodiments of FIGS. 6 and 7, circular openings 25 have been cut in edge caps 21 and 21a, so as to reduce weight and material usage. The cut-out segments can be recycled or reprocessed.

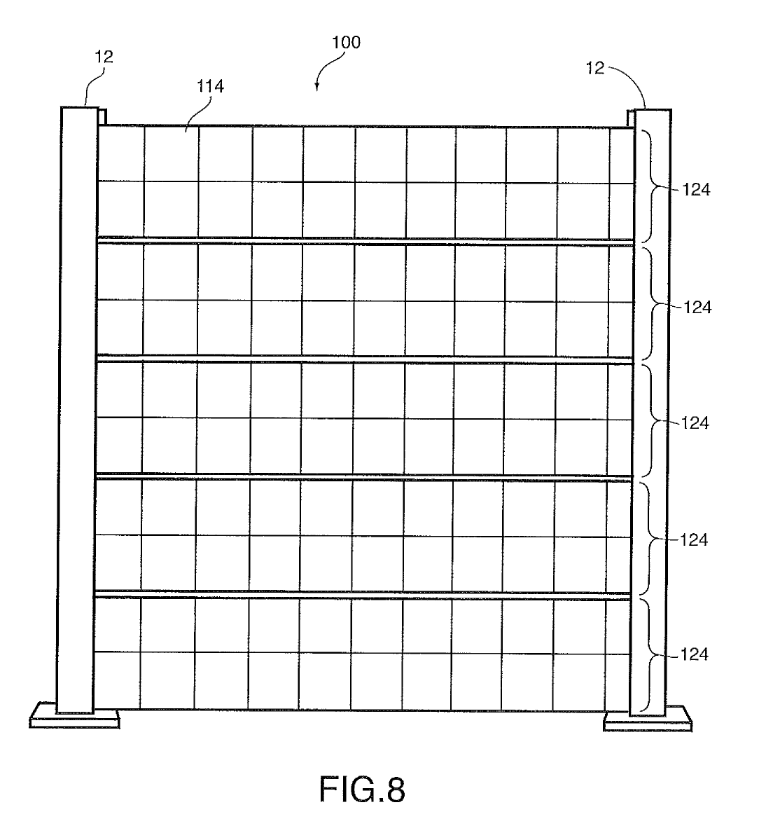

Referring to FIG. 8, there is shown an alternate embodiment of a noise barrier 100 according to the invention. In this embodiment, an alternate wall panel 114 is held in place, in generally the same manner as previously described above, between support posts 12. As illustrated, wall panel 114 comprises five noise barrier panel assemblies 124 but as before other numbers could be used.

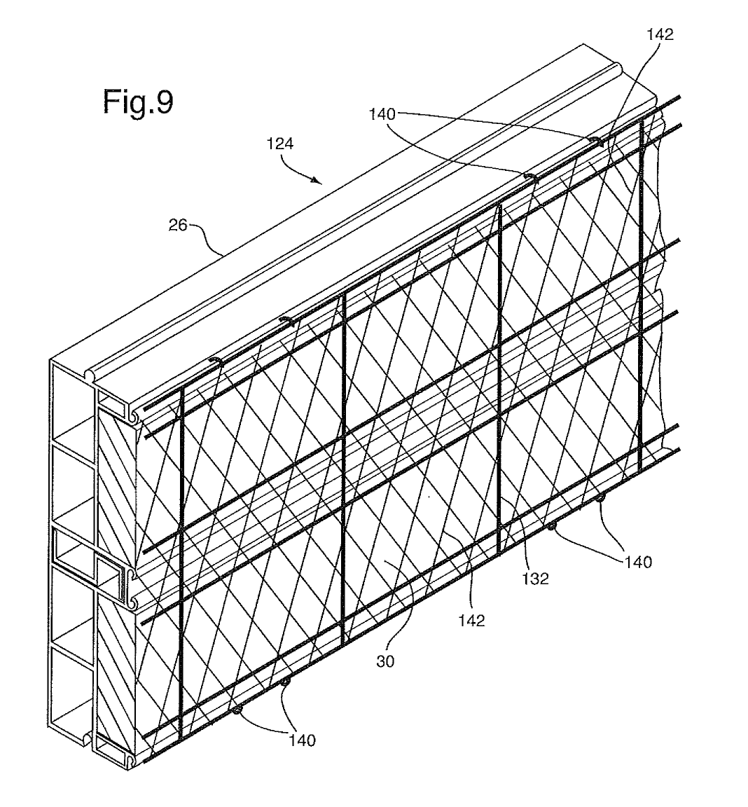

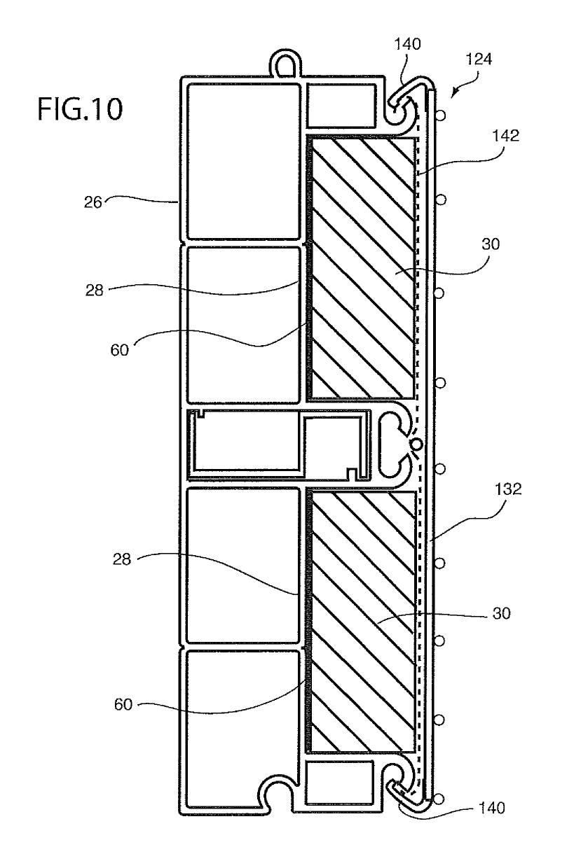

Referring to FIGS. 9 and 10, panel assembly 124 comprises a base panel 26, as described above. In addition, batts of sound-attenuating insulation 30 are located as described above, except that in this embodiment if insulation 30 has a moisture resistant layer 60, preferably such layer 60 will be located adjacent exterior surface 28. In this embodiment, face panel 132 comprises a lattice or mesh structure. Preferably, face panel 132 is made of wire mesh, with cells about 6 inches by 6 inches. Face panel 132 is provided with upper and lower hooks 140 to attach to the lips 38 of base panel 26. In the illustrated embodiment, face panel 132 is sized to extend across two neighbouring batts of insulation 30. In addition to face panel 132, an inner mesh or net 142 may be pressed into place between face panel 132 and batts of insulation 30.

The purpose of the open lattice work of face panel 132 and of any inner mesh 142 is to provide a support structure for plants, such as vines, ivies and the like, that may be planted adjacent to the noise barrier 100. Any moisture which may be absorbed by the insulation material 30 will be available to the plants.

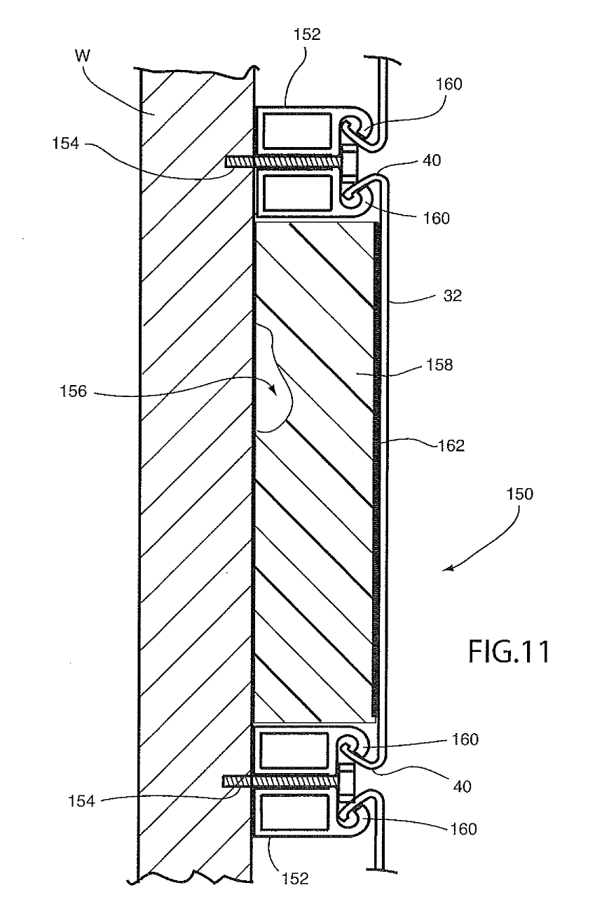

Referring now to FIG. 11, there is shown an alternate embodiment for retrofitting sound-attenuating insulation to an existing wall surface W, thereby converting such wall into a noise barrier structure 150. The retrofit components may be supplied in kit form. The kit will comprise at least two channel-defining rail members 152. The rail members 152 are mounted to pre-existing wall surface W by any suitable means, such as fasteners 154, in generally parallel spaced apart relationship a pre-determined distance apart from each other, so as to define an insulation receiving channel 156 therebetween. In normal use, rail members 152 will be mounted generally horizontally. However, it is possible that, for artistic or other purposes, they could be mounted in any desired orientation. Indeed, if the area of the wall is large enough, for artistic purposes, the different rail member components could be provided in a variety of different orientations, in essence in a mosaic-type pattern. Rail members 152 have two inwardly oriented hook-shaped lips 160.

The kit may also include batts of sound-attenuating insulation 158 which will be located in channel 156 adjacent the wall surface W. If the insulation has a moisture resisting layer 162, preferably such layer 162 will be located away from wall surface W.

The kit will additionally include at least one face panel 32. When rail members 152 are duly mounted to wall surface W and insulation 158 put in place, the face panel hook structure 40 may be slid or snapped into place into engagement with lips 160.

The wall surface W to which noise barrier structure 150 may be attached could be the reverse side of a wall panel of the type described above, namely wall panel 14. In this fashion, both sides of wall panels 14 may be made sound-attenuating as well as provide various decorative options as previously described.

If it is desired merely to achieve decorative effects as described above, it is possible to attach face panel 32 to rail members 152 without including any insulation 158 in channel 156.

Although various preferred embodiments of the present invention had been described herein in detail, it will be appreciated by those skilled in the art that variations may be made thereto without departing from the spirit and scope of the invention.

1. A noise barrier panel assembly comprising
a base panel;
sound-attenuating insulation located adjacent an exterior surface of the base panel;
an insulation retaining structure to secure the insulation in fixed relation to the base panel.

2. A noise barrier panel assembly as claimed in claim 1 wherein the insulation retaining structure comprises a face panel extending across the insulation and attached to the base panel.

3. A noise barrier panel assembly as claimed in claim 2 wherein the base panel defines at least one insulation receiving channel and the insulation is located in the at least one channel.

4. A noise barrier panel assembly as claimed in claim 3 wherein the base panel is made of extruded thermoplastic.

5. A noise barrier panel assembly as claimed in claim 4 wherein the face panel defines sound-admitting openings.

6. A noise barrier panel assembly as claimed in claim 4 wherein the base panel defines a face panel attachment structure and the face panel defines cooperating base panel attachment structures whereby the face panel and the base panel may be attached together.

7. A noise barrier panel assembly as claimed in claim 6 wherein the face panel attachment structure has a generally hook-shaped cross-section on either side of the at least one channel and the base panel attachment structures comprise cooperating hook structures engaged with the hook-shaped face panel attachment structure.

8. A noise barrier panel assembly as claimed in claim 7 wherein the face panel is extruded and the cooperating hook structures comprise hook-engaging side structures extending along each side of the face panel.

9. A noise barrier panel assembly as claimed in claim 8 wherein the face panel defines sound-admitting openings and the insulation comprises mineral wool batts having a moisture barrier on at least one side and said at least one side is adjacent the face panel.

10. A noise barrier panel assembly as claimed in claim 7 wherein the face panel comprises a lattice structure.

11. A noise barrier comprising
at least two generally vertical support posts;
at least one wall panel with sides attached to the support posts;
sound-attenuating insulation located adjacent an exterior surface of the wall panel;
an insulation retaining structure to secure the insulation in fixed relation to the base panel.

12. A noise barrier as claimed in claim 11 wherein the wall panel comprises multiple noise barrier panel assemblies, each said assembly comprising
a base panel;
sound-attenuating insulation located adjacent an exterior surface of the base panel
an insulation retaining structure to secure the insulation in fixed relation to the base panel.

13. A noise barrier as claimed in claim 12 wherein the insulation retaining structure comprises a face panel extending across the insulation and attached to the base panel.

14. A noise barrier as claimed in claim 13 wherein the base panel defines at least one insulation receiving channel and the insulation is located in the at least one channel.

15. A noise barrier as claimed in claim 14 wherein the base panel and the face panel are made of extruded thermoplastic and the face panel defines sound-admitting openings.

16. A noise barrier as claimed in claim 15 wherein the base panel defines a generally hook-shaped cross-section on either side of the at least one channel and the face panel defines cooperating hook-engaging side structures extending along each side of the face panel whereby the face panel and the base panel may be attached together.

17. A noise barrier as claimed in claim 16 wherein the insulation comprises mineral wool batts having a moisture barrier on at least one side and said at least one side is adjacent the face panel.

18. A noise barrier as claimed in claim 17 wherein the noise barrier panel assemblies are stacked on top of each other.

19. A noise barrier as claimed in claim 18 wherein each base panel defines upper and lower registration means to cooperate with corresponding structures in an adjacent panel assembly whereby adjacent panel assemblies are secured in registered relationship to each other.

20. A noise barrier as claimed in claim 19 wherein the support posts define channels in which the sides of the wall panel are secured.

21. A noise barrier as claimed in claim 13 wherein the face panel comprises at least one lattice structure.

22. A noise barrier retrofit kit adapted to be attached to a wall surface comprising
at least two channel-defining members adapted to be mounted to the wall surface in generally parallel spaced apart relationship, so as to define an insulation receiving channel therebetween;
sound-attenuating insulation adapted to be located in the channel adjacent the wall surface;
at least one insulation retaining structure adapted to be secured to the channel-defining members whereby to hold the insulation in place.

23. A noise barrier retrofit kit as claimed in claim 22 wherein the insulation retaining structure comprises a face panel extending across the insulation and attached to the channel-defining members.

24. A noise barrier retrofit kit as claimed in claim 23 wherein the channel-defining members and the face panel are made of extruded thermoplastic and the face panel defines sound-admitting openings.

25. A noise barrier retrofit kit as claimed in claim 24 wherein the channel-defining members have generally hook-shaped cross-sections along edges thereof and the face panel defines cooperating hook-engaging side structures extending along each side of the face panel whereby the face panel and two adjacent channel-defining members may be attached together.

26. A noise barrier comprising
a wall surface;
at least two channel-defining members mounted to the wall surface in generally parallel spaced apart relationship, so as to define an insulation receiving channel therebetween;
sound-attenuating insulation located in the channel adjacent the wall surface;
an insulation retaining structure secured to the channel-defining members whereby to hold the insulation in place.

27. A noise barrier as claimed in claim 26 wherein the insulation retaining structure comprises a face panel extending across the insulation and attached to the channel-defining members.

28. A noise barrier as claimed in claim 27 wherein the channel-defining members and the face panel are made of extruded thermoplastic and the face panel defines sound-admitting openings.

29. A noise barrier as claimed in claim 28 wherein the channel-defining members have generally hook-shaped cross-sections along edges thereof and the face panel defines cooperating hook-engaging side structures extending along each side of the face panel whereby the face panel and two adjacent channel-defining members may be attached together.
